(19) United States
(12) Patent Application Publication
(10) Pub. No.: US 2008/0301185 A1
(43) Pub. Date: Dec. 4, 2008

(54) Property Validation Framework

(75) Inventors: Taleb Tewfik Zeghmi, Seattle, WA (US); Ronald R. Martinsen, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/755,803

(22) Filed: May 31, 2007

(51) Int. Cl. G06F 17/30

(52) U.S. Cl. 707/104.1

(57) ABSTRACT

Aspects of the subject matter described herein relate to validating properties. In aspects, a property is associated with one or more validators. Each validator includes actions to take to determine whether a feature of the property is valid. Multiple validators may be executed for a single property. A group of validators may be identified by an identifier. In addition, properties may be grouped into collections which may be grouped into other collections and so on. Each collection may also be associated with one or more validators to validate properties within the collections.

### BACKGROUND

Most layered applications contain validation logic that is dispersed across several layers of the application. For example, the validation logic may be dispersed in user interface and business logic layers. One solution to this is to have a shared library of validation functions. Whenever validation is needed in a layer, a function in the library is called from the appropriate layer. This model has problems with extending or changing the validation. For example, when an additional validation function is added, a developer must ensure that this function is invoked at every location where a change to the data may occur. If the developer misses a location, data may not be validated.

### SUMMARY

Briefly, aspects of the subject matter described herein relate to validating properties. In aspects, a property is associated with one or more validators. Each validator includes actions to take to determine whether a feature of the property is valid. Multiple validators may be executed for a single property. A group of validators may be identified by an identifier. In addition, properties may be grouped into collections which may be grouped into other collections and so on. Each collection may also be associated with one or more validators to validate properties within the collections.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an application and its related properties in accordance with aspects of the subject matter described herein;

FIG. 3 is a block diagram that represents an exemplary device configured to operate in accordance with aspects of the subject matter described herein; and

FIGS. 4-5 are flow diagrams that generally represent exemplary actions that may occur in accordance with aspects of the subject matter described herein.

### DETAILED DESCRIPTION

### Exemplary Operating Environment

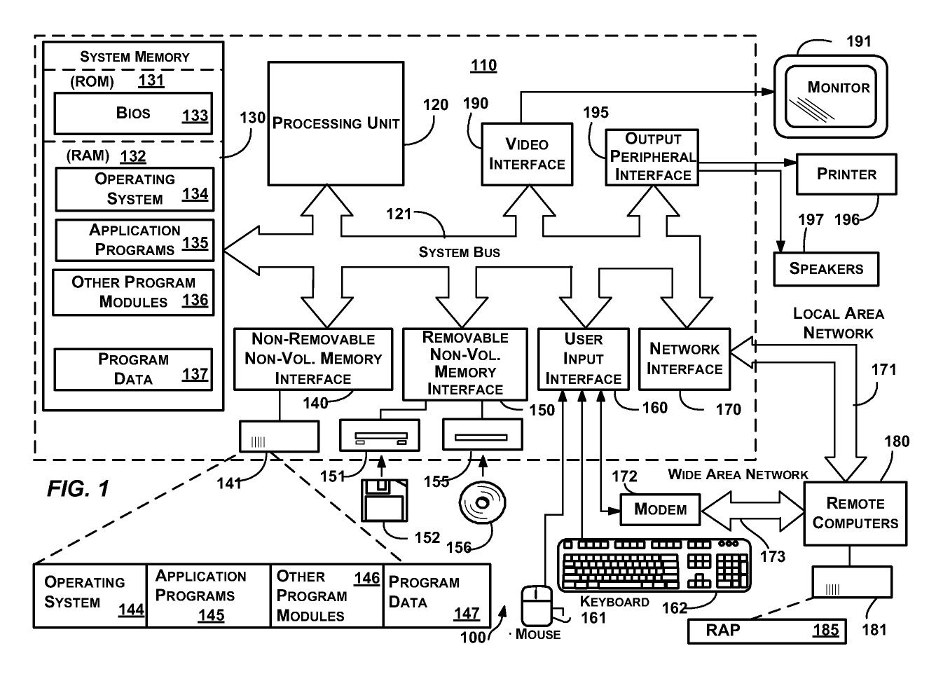

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Property Validation

As mentioned previously, an application may need validation logic to validate data. The data (sometimes referred to as a property or properties) to validate may be received in a variety of ways including a user interface, a collection of data included in an XML file, a database, a file, and the like, etc.

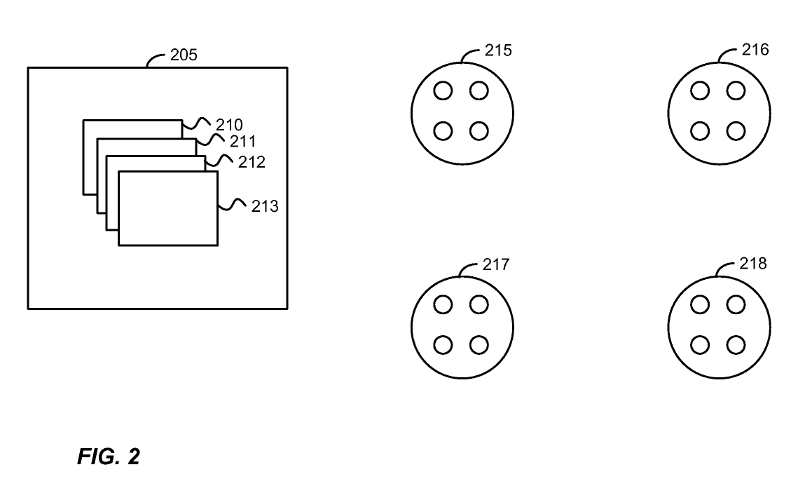

FIG. 2 is a block diagram that generally represents an application and its related properties in accordance with aspects of the subject matter described herein. In FIG. 2, data structures 215-218 and a user interface 205 including data input screens 210-213 are illustrated.

An application or other process may include a user interface 205 that includes some data input screens (e.g., data input screens 210-213) for entering or modifying data. For simplicity in presentation, the term “application” is sometimes used herein to refer to the entity that takes advantage of aspects of the subject matter described herein, but it should be understood that in alternative embodiments, other processes and/or components such as kernel-mode processes, operating system components, database management system components, file system components, installation tools, combinations of the above, threads of the above, and the like may employ aspects of the subject matter described herein.

The data input screens 210-213 may include one or more controls capable of receiving data. For example, an application may include text boxes, grid controls, tool bars, list box items, combo boxes, buttons, panels, menus, sub menus, and many other controls as will be readily recognized by those skilled in the art. These controls may be used to enter or modify data associated with a program. For example, an installation wizard may collect data in various data input screens. The wizard may then use this data to install or configure software package, for example.

As another example, a Web shopping cart interface may include several screens to gather information that is needed to bill and ship a product to a customer. A computer seller that allows a user to configure a computer system via a Web site before buying the computer system may have many screens for collecting data about what options (e.g., hardware components, software components, peripherals, and the like) that the user wants with the computer system.

Each screen may include data that relates to one or more properties. A property as used herein includes data that may be entered, changed, or otherwise manipulated via a user interface, a program, or otherwise. A property may also include data that is derived from the data above. A property may also include methods associated with the data.

Properties obtained from a control may be stored in a variable or other data structure in volatile or non-volatile memory. For example, referring to FIG. 2, if each of the data input screens 210-213 included four data values to fill in, the four data structures 215-218 might be used. Each of the data structures may have fields for the properties (which are represented by the circles within the data structures 215-218).

A data structure such as the data structures 215-218 may comprise a collection of properties. In one embodiment, a data structure such as one of the data structures 215-218 may implemented as a dictionary object having key, property pairs. When the dictionary object is given a key associated with a property stored in the dictionary object, it returns the associated property.

An application developer may desire to constrain the properties to certain values. For example, in Internet addresses, a developer may desire to have a number between 0 and 255 inclusive for each of the parts of the address. For ages, a developer may desire to have a positive number. For strings, a developer may desire to constrain the string to a certain size or to include or exclude certain characters in the string, for example.

An example that many users are familiar with is that of entering or changing a password. In this case, to create a strong password, a developer may wish to constrain the password to strings greater than a certain length. In addition, the developer may also desire that the password include certain non-letter characters. Furthermore, the developer may desire that the password not have been used in the last fifteen password changes.

In accordance with aspects of the subject matter described herein, a property may be associated with one or more validators. A validator is a function that may include one or more programming steps that determine whether a feature of an associated property is valid. The term “feature” is used to indicate that while the property may be valid as far as the programming steps of the validator are concerned, that another validator may determine that the property is not valid. The term “feature” may include more than one characteristic of the property. If only one validator is associated with a property and the validator determines that the features it checks are valid, this is synonymous with the property being valid.

Sometimes below, it is indicated that a validator determines that a property is valid or invalid. It is to be understood that this means that as far as the validator is concerned, the property is valid. As indicated above, another validator may find that the property is invalid.

A validator may return, for example, a Boolean value that indicates that the property is valid or invalid. A validator may also include a list of problems with a property that is not valid. For the password example, this list of problems may include, for example, the password being too short, not including non-letter characters, being used recently, etc.

In one embodiment, a validator takes as a parameter a property. Using the value of the property, the validator determines if the property is valid. If the property is not valid, the validator indicates so by calling a method of the property. Some exemplary pseudo-code to perform this is as follows:

```
Boolean Validate(Property p)
{
    // Perform steps to determine if p.value meets
    //  specified criteria
    if (p.value does not meets specified criteria)
    {
        p.FailedValidation
        return False;
    }
    // P is valid if the program gets to here.
    return True;
}
```

In one embodiment, a validator may be called by specifying a name (e.g., identifier) associated with the property and a validate method. For example, if a user data property having the name of “type” is contained in a userdata object, a validate method associated with the “type” property may be called as follows:

userdata[“type”].Validate( );

The construct userdata[“type”] returns an object that includes the “type” property. This “type” property includes a method (e.g., Validate) that can be called to validate the data within the property. It will be recognized by those skilled in the art that this embodiment of validating properties tightly couples the property to its validate method.

Additional validators may also be added to a particular property. In one implementation, this may be done by the following pseudo-code:

userdata[“type”].AddValidator(FunctionNameofValidator);

When the validate method of the property is called, the validators of the property may be called in the order in which they were added, for example. A property value is valid if each validator associated with the property indicates that the value is valid. If any validator associated with the property indicates that the value is not valid, the property is not valid. If there are no validators associated with a property, the property may be assumed to be valid by default.

In the password example above, a data input screen may request a password. It may be desirable to have immediate user feedback for certain of the criteria established for valid passwords. For example, it may be desirable to have an icon turn green when the user has entered enough letters to exceed the minimum length of a valid password. It may also be desirable to have another icon turn green when non-alphanumeric characters are entered. After the user tabs out of the password field, closes the window, hits an OK button, or takes another action outside the password field, it may be desirable to check whether the password has been used as one of the last twenty passwords, for example.

To have this occur, in one example, a password property object may be created. In one embodiment, three validators for the above three criteria may be associated with the password property. In a keystroke event of a user interface control associated with entering the password, the password property value may be updated to include data corresponding to the new keystroke. In addition, the validators associated with the length and non-alphanumeric criteria may be called to determine whether to light the icons. Because determining whether the password has been used in the last twenty times may be a more expensive operation, this validator may be called after the user takes action outside the password field.

In another embodiment, two validators may be associated with the password property. One of the validators may include actions for checking validation after each new keystroke. This validator may check the length and whether non-alphanumeric characters have been used in the password. This validator may also light up the icons associated with these criteria as appropriate.

The second of the validators may include expensive operations such as checking a database to determine whether the password has been used in the last twenty password changes for the user. This validator may be called after the user takes actions outside the password field.

In another embodiment, validators may be grouped together by passing the same identifier when adding another validator. For example, instead of putting all the code for validating inexpensive validators in one validator, the code may be placed in separate validators which are then both associated with a property using the same identifier. When a validate method is called with the identifier, all validators associated with the identifier may be called.

More, fewer, or different validators may be used without departing from the spirit or scope of aspects of the subject matter described herein.

Properties may also be validated at a screen or multi-screen level. For example, it may be difficult or impossible to validate some properties until other properties have been entered. For example, in a data input screen that receives an e-mail address, the input screen may request that the user enter the e-mail address in two separate fields to ensure that the e-mail address was not mistyped.

In the computer-ordering example above, information about computer options may be entered on multiple screens. A user may select a particular graphics card on one screen and a particular monitor on another screen. The graphics card may not be compatible with the monitor. This may be detected in a multi-screen level type validation, for example.

To address these types of issues, properties may be grouped in a collection (sometimes called a property bag). The property bag may have a validate method associated therewith. When the validate method of the property bag is called without an identifier of a validator, it may call the validate methods of each of the properties within the property bag in addition to any validators associated with the property bag itself. When the validate method of a property bag is called with a validator identifier, just the validator associated with the validator identifier may be called. In this way, validation across a collection of properties may be accomplished.

Furthermore, property bags may be collected in other collections (also sometimes called property bags or global property bags). For example, in the computer-ordering example above, the graphics card may be selected in one screen while the monitor may be selected in another. The screen in which the graphics card is selected may be associated with one property bag while the screen in which the monitor is selected may be associated with another property bag. A global property bag may include both the property bags.

The global property bag may be associated with a validate method. When the validate method of the global property bag is called without a validator name, it may call the validate methods of each of the property bags it contains in addition to any validators associated with the global property bag. When the validate methods of the property bags are called, they may call validate methods of properties within the property bag in addition to any validators associated with the property bags.

When the validate method of the global property bag is called with a validator identifier, it may call the validator method of the validator associated with the validator identifier. This validator may selectively determine to call validators of property bags or properties within the global property bag. In these ways, validation across a collection of property bags may be accomplished.

Global property bags may be collected into other property bags which may be collected into yet other property bags and so on. It will be recognized that this gives a very flexible way of validating properties, collections of properties, collection of collections of properties, and so forth.

Validators for properties or property bags may be named (e.g., identified) according to their function. For example, a property bag may have a validator with a “syntax” identifier. This validator may check the syntax for all properties within the property bag. As another example, a property bag may have a validator associated with “expensive” validation operations. For example, checking a database to determine whether a user name has already been used may be an expensive operation. To call this validator, a program may use the appropriate property bag and pass it the identifier (e.g., “expensive”) associated with expensive validation operations.

In one embodiment, a call to the validate method of a property without a parameter causes all validators associated with the property to be called. A call to a validate method of a property with an identifier parameter causes just the validator(s) associated with the identifier to be called. As discussed above, this works similarly for property bags.

In one embodiment, every property contains a nameless parent validation group. Identified property validators and/or validation groups may be added to this nameless group. When p.Validate( ) is called, all the named and nameless validators are called. Likewise, identified (named) validation groups can be added to other named validation groups to aid in grouping and organizing validation functions. One example of this is an email property which has a validator grouping named “expensive.” Within this grouping many different validation groupings may be added such as “AD,” “uniqueness,” and so forth. Then:

```
Bag[”email”].Validate( ); // validates all groupings
Bag[”email”].Validate(”expensive”); // Validates the
    // expensive grouping including all sub groupings
Bag[”email”].GetValidator(”expensive”).Validate(”AD”);
    // Validates the AD validation grouping within the
    // expensive grouping:
```

It will be recognized that this allows validation actions to be grouped via validators. Validators so grouped may be called without calling all the validators associated with a property or collection. Grouping may be done to perform inexpensive validation operations at one point and expensive operations at another point, for example. Calling a specific validator may be done, for example, by passing an identifier of a validator to the validate method. When the validate method is called without an identifier, it may in turn call all the validators associated with a property or property bag.

Below is some more pseudo-code that illustrates some examples of aspects of the subject matter described herein. Although the pseudo-code below indicates a guideline for implementing aspects of the subject matter described herein, it will be readily recognized that other mechanisms may also be used without departing from the spirit or scope of the subject matter described herein.

```
void CreatePropertyBagsAndValidation
{
    GlobalPropertyBag gEag = new GlobalPropertyBag( );
    // create property bag and properties for the UserData PropertyBag
    //
    // add the PropertyBag to the global GlobalPropertyBag
    gBag.Add(“userdata”, new PropertyBag( ));
    // Create the Property entries
    gBag[“userdata”].Add(“email”, new Property( ));
    gBag[“userdata”].Add(“username”, new Property( ));
    // add a validator to validate the syntax only
    gBag[“userdata”][“email”].AddValidator(“syntax”,
      EmailSyntaxValidation);
    // performs a validation that can be expensive
    // AD Stands for Active Directory
    gBag[“userdata”][“email”].AddValidator(“AD”,
    EmailADValidation);
    // PropertyBag wide validator, intra-field validation
    // this validator function is called whenever
    // propBag[“userdata”].Validate( ) is called.
    // Note the different syntax used to add a new validator
    gBag[“userdata”].Validators += UserDataValidation;
}
//
// UI events that warrant different validaitons
//
// on every keystroke validate the email syntax
void OnTextChangeEvent( )
{
    bool f = gBag[“userdata”][“email”].Validate(“syntax”);
    // display errors if any
    gBag[“userdata”][“email”].Errors // get the errors if any
}
// when OK is clicked validate whole propertybag
void OnClickOk( )
{
    // This validate calls all of the validators
    // added to the PropertyBag
    bool f = gBag[“userdata”].Validate( );
    // display errors if any
    gBag.Errors; // get the errors if any
}
//
// Validators, validation functions
//
bool UserDataValidation(Propertybag bag)
{
    // validates username against email
}
bool EmailSyntaxValidation(Property property)
{
    // validates the email syntax
}
```

Below is some pseudo-code that represents an exemplary validation interface:

```
/// <summary>
    /// The signature of a validation function.
    /// </summary>
    /// <param name=“data”>The validateable object to validate.</param>
    /// <returns>True when valid otherwise false.</returns>
    public delegate bool Validator(T data) // where T implements
                                          // IValidation
    /// <summary>
    /// Named validation grouping definition.
    /// </summary>
    interface IValidation
    {
        /// <summary>
        /// Validation grouping name.
        /// </summary>
        string Name;
        /// <summary>
        /// Method by which to add validators to this named validation.
        /// Added function has a Validator function signature.
        /// </summary>
        /// <example>
        /// // p is a validateable object
        /// p.Validators += MyValidatorFunction;
        /// </example>
        public event Validator Validators;
        /// <summary>
        /// Invokes all validators associated with this named validation
        /// grouping.
        ///
        /// Also calls Validate( ) on all sub validation groupings. If any
        /// return false then this returns false.
        /// If no validators are added then this returns true.
        /// </summary>
        /// <returns>
        /// True when all validators and sub validation validators
        /// return true, otherwise false.
        /// </returns>
        bool Validated( );
        /// <summary>
        /// Much like Validate( ) except that this validates only
        this named
        /// validation grouping.
        /// </summary>
        bool Validate(string name);
        /// <summary>
        /// Adds a validator by name and returns a validation grouping
        /// to which other validators or validation groupings can
      be added.
        /// </summary>
        IValidation AddValidator(string name, Validator<T> validator);
        /// <summary>
        /// Returns the named sub validation by name. Adds ability
        /// to have validation groups within other validation groups.
        /// </summary>
        Ivalidation GetValidator(string name);
        /// <summary>
        /// Method that validator functions use to report failures.
        /// </summary>
        void OnFailedValidation(string reason);
        /// <summary>
        /// List of failures of the last failed validation.
        /// </summary>
        List<string> Errors;
}
```

The IDictionaryValidation interface is defined like IValidation except that it ensures, using generics or compiler type checking, that all dictionary values are also validateable (i.e., implement IValidation). Implementers of the Validate( ) function of this interface call Validate( ) on every value.

Below is some pseudo-code that represents an exemplary IDictionaryValidation interface:

```
/// <summary>
    /// Dictionary data type named validation where every value is also
    /// validateable.
    /// Validate( ) implementation calls Validate( ) on every value.
    /// </summary>
    /// <typeparam name=“TKey”>
    /// The dictionary key type (most often is a string).
    /// </typeparam>
    /// <typeparam name=“TValue”>
    /// The type of the dictionary value that must be validateable.
    /// </typeparam>
    interface IDictionaryValidation<TKey, TValue> :
        IValidation,
        IDictionary<TKey, TValue>
            where TValue : IValidation // Dictionary values also
            implement
                                      // IValidation
    {
    }
```

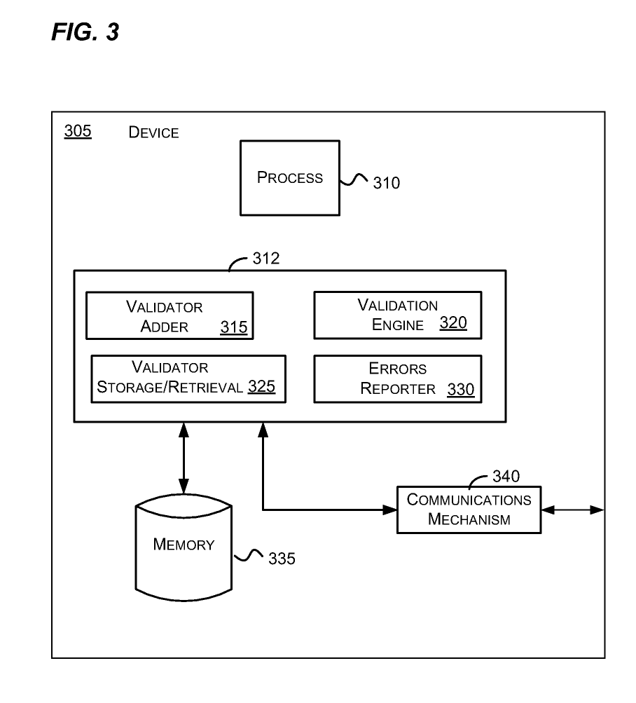

FIG. 3 is a block diagram that represents an exemplary device configured to operate in accordance with aspects of the subject matter described herein. The device 305 may include a process 310, a validation module 310, memory 335, and a communications mechanism 340. The validation module 312 may include a validator adder 315, a validation engine 320, a validator storage/retrieval 325, and an errors reporter 330.

In one embodiment each of the entities 310-330 may comprise one or more user or kernel-mode processes or threads thereof.

The process 320 may comprise an application, operating system component, thread, or the like. In one embodiment, the process 310 may comprise a user interface component of an application that is in charge of receiving user input and ensuring that the input is valid. In another embodiment, the process 310 may comprise a process that receives a file of data to validate as described previously.

The validation module 312 includes a collection of validation components that may be used to validate data. The validation module 312 may include more, fewer, and/or other components than those shown in FIG. 3 without departing from the spirit or scope of aspects of the subject matter described herein. Furthermore, in other embodiments various components shown within the validation module 312 may be joined together or separated into other components.

The validator adder 315 operates to add validators for properties or collections. The add validator may associate a validator with a property or collection using an identifier associated with the validator and the property or collection as previously indicated.

The validator storage/retrieval 320 operates to store and retrieve validators from the memory 335. The validator storage/retrieval 320 may use any data store and format that is capable of storing and retrieving validators including a database, a dictionary object, a file, a data structure in memory, and so forth. Validators may be stored in the memory 335.

The validation engine 320 operates to validate properties or collections via the validators stored in the memory 335. In response to receiving a request to validate a property or collection, the validation engine 320 may execute one or more validators.

The error generator 325 is operable to indicate errors associated with validating a property or collection. The error generator 325 may store a list of errors associated with a validation as previously indicated. The error generator 325 is also further operable to provide errors in response to a request for the errors.

The memory 335 is any storage media capable of storing computer data and/or code. The memory 335 may be volatile or non-volatile. An example of a suitable media for the memory 335 is the computer-readable media discussed in conjunction with FIG. 1.

The communications mechanism 340 allows the device 305 to communicate with other devices if needed to validate properties or collections. The communications mechanism 340 may be a network interface or adapter 170, modem 172, or any other mechanism for establishing communications as described in conjunction with FIG. 1.

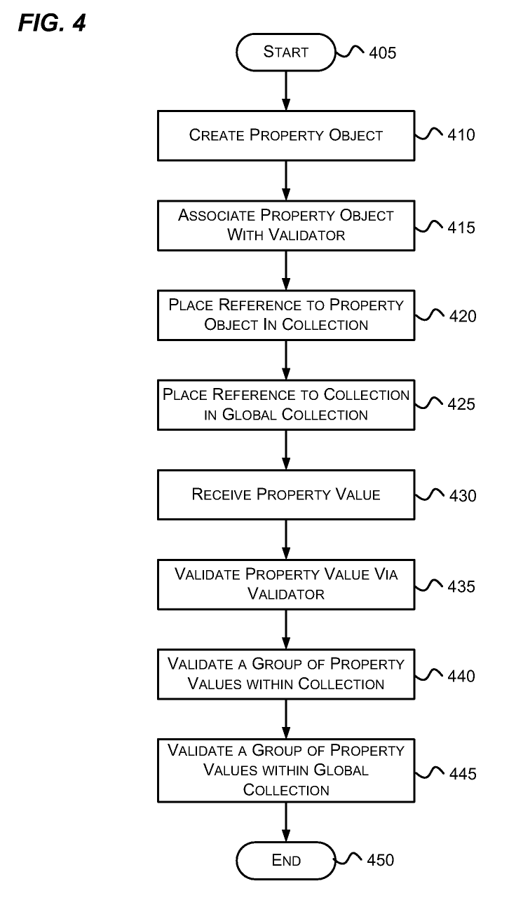

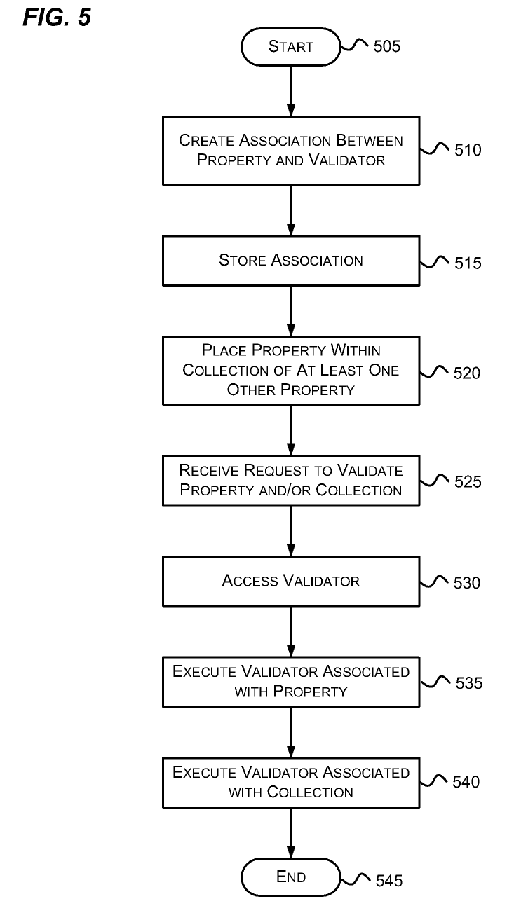

FIGS. 4-5 are flow diagrams that generally represent exemplary actions that may occur in accordance with aspects of the subject matter described herein. For simplicity of explanation, the methods described in conjunction with FIGS. 4 and 5 are depicted and described as a series of acts. It is to be understood and appreciated that the aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methods in accordance with aspects of the subject matter described herein. In addition, those skilled in the art will understand and appreciate that the methods could alternatively be represented as a series of interrelated states via a state diagram or as events.

Turning to FIG. 4, the actions begin at block 405. At block 410, a property object is created. For example, referring to FIG. 3, the process 310 creates a property object. A property object may include a property value and associated methods, for example.

At block 415, the property object is associated with a validator. For example, referring to FIG. 3, the validator adder 315 associates the validator with a property object. This may be done by using an identifier of the validator as indicated previously.

At block 420, a reference to the property object is placed in a collection. For example, referring to FIG. 3, the process 310 puts a reference to the property object within a collection. A reference may include a pointer, identifier, or some other thing that allows the collection to access the property object. In anther embodiment, the property object itself is placed within the collection.

At block 425, a reference to the collection is placed in a global collection. For example, referring to FIG. 3, the process 310 places a reference to the collection within another collection. In anther embodiment, the collection itself is placed within the other collection.

At block 430, the property value is received. For example, referring to FIG. 3, the process 310 receives the property value from a user interface or file as described previously.

At block 435, a property is validated via a validator. For example, referring to FIG. 3, the validation engine 320 requests the validator storage/retrieval 325 to retrieve (or provide a reference to) one or more validators. The validation engine 320 then validates the property via the one or more validators.

At block 440, a group of properties values within a collection is validated. For example, referring to FIG. 3, the validation engine 320 requests the validator storage/retrieval 325 to retrieve (or provide a reference to) a one or more validators associated with the collection and/or properties therein. The validation engine 320 then validates the properties within the collection via the one or more validators.

At block 445, a group of properties values within a global collection is validated. For example, referring to FIG. 3, the validation engine 320 requests the validator storage/retrieval 325 to retrieve (or provide a reference to) a one or more validators associated with the global collection, collections therein, and/or properties within the collections. The validation engine 320 then validates the properties via the one or more validators.

At block 450, the actions end.

Turning to FIG. 5, the actions begin at block 505.

At block 510, an association between a property and validator is created. For example, referring to FIG. 3, the validator adder 315 associates a property with a validator as described previously.

At block 515, the association is stored. For example, referring to FIG. 3, the validator storage/retrieval 325 stores the association in memory 335.

At block 520, the property is placed within a collection of at least one other property. For example, referring to FIG. 3, the process 310 places the property within a collection. In another embodiment, a reference to the property may be placed within the collection.

At block 525, a request to validate the property and/or a collection is received. For example, referring to FIG. 3, the validation module 312 receives a request to validate a property and/or collection.

At block 530, a validator is accessed. For example, referring to FIG. 3, the validation engine 320 requests the validator storage/retrieval 325 to retrieve (or provide a reference to) a one or more validators associated with the collection and/or properties therein.

At block 535, one or more validators associated with the property are executed if the request indicates validating a property. For example, referring to FIG. 3, the validation engine 320 validates the property via the one or more validators.

At block 540, one or more validators associated with the collection are executed if the request indicates validating a collection. For example, referring to FIG. 3, the validation engine 320 validates properties within a collection via the one or more validators.

At block 545, the action end.

As can be seen from the foregoing detailed description, aspects have been described related to a validation framework. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
creating a property object that includes or is associated with memory for storing a property value and that also includes or is associated with a method for validating the property value;
associating the property object with a validator that operates to validate a feature of the property value, the validator being identified to the property object by an identifier, the validator including actions to take to determine whether the feature of the property value is valid, the method for validating the property value calling the validator at least when the method for validating the property value is passed the identifier; and
validating the feature of the property value via the validator.

2. The computer-readable medium of claim 1, further comprising receiving a value to place in the memory.

3. The computer-readable medium of claim 2, wherein receiving a value to place in the memory comprises receiving the value from a user interface.

4. The computer-readable medium of claim 2, wherein receiving a value to place in the memory comprises receiving the value from a file.

5. The computer-readable medium of claim 1, wherein validating the feature of the property value via the validator comprises creating error information if the feature of the property value is not valid.

6. The computer-readable medium of claim 1, further comprising associated another validator with the property object using the identifier and validating another feature of the property value via the other validator.

7. The computer-readable medium of claim 6, wherein each validator associated with the property is called by the method for validating the property value when the method is passed no identifier.

8. The computer-readable medium of claim 1, further comprising placing a reference to the property object in a first collection with at least one other property object and validating at least some property values of the property objects within the first collection as a group.

9. The computer-readable medium of claim 8, further comprising validating interdependent property values of each property object within the first collection, wherein an interdependent property value comprises a property value that is potentially valid or invalid depending on another property value within the first collection.

10. The computer-readable medium of claim 8, further comprising placing the first collection and a second collection of property objects within a third collection and performing validation on a property value of a property object within the first collection that is dependent for validation upon a property value of a property object within the second collection.

11. A method implemented at least in part by a computer, the method comprising:
creating an association between a property and a validator, the validator being associated with an identifier;
storing the association in memory;
receiving a request to validate the property; and
accessing the validator in response to the request.

12. The method of claim 11, wherein receiving a request receiving a request to validate the property comprises calling a validate method associated with the validator.

13. The method of claim 11, wherein the memory comprises one or more of volatile and non-volatile memory.

14. The method of claim 11, wherein creating an association between a property and a validator comprises passing an object including the property and the identifier of the validator to a dictionary object.

15. The method of claim 11, further comprising creating another association with another validator, the other validator associated with another identifier.

16. The method of claim 15, further comprising executing both validators in response to the request.

17. The method of claim 11, further comprising placing the property within a collection of at least one other property, each property within the collection being validated in response to calling a validate method associated with the collection.

18. The method of claim 11, wherein the property comprises one or more of data and an object including data and at least one method.

19. In a computing environment, an apparatus, comprising:
a validator adder operable to associate a validator with a property or collection of properties or collections;
a validator storage/retrieval operable to store and retrieve validators from a memory;
a validation engine operable to receive a request to validate a property or collection and to execute one or more validators in response thereto; and
an errors reporter operable to indicate errors associated with validating a property or collection and further operable to provide the errors in response to a request therefor;

20. The apparatus of claim 19, wherein the validator storage/retrieval stores and retrieves validators based on identifiers associated with the validators, each validator being associated with an identifier, an identifier being capable of being associated with one or more validators.
